(19) United States
(12) Patent Application Publication
(10) Pub. No.: US 2013/0249318 A1
(43) Pub. Date: Sep. 26, 2013

(54) ELECTRONIC DEVICE

(71) Applicants: TAO WANG, Shenzhen City (CN); XUE-BING DENG, Shenzhen City (CN); HAI-LONG CHENG, Shenzhen City (CN)

(72) Inventors: TAO WANG, Shenzhen City (CN); XUE-BING DENG, Shenzhen City (CN); HAI-LONG CHENG, Shenzhen City (CN)

(21) Appl. No.: 13/629,713

(22) Filed: Sep. 28, 2012

(30) Foreign Application Priority Data
Mar. 20, 2012 (CN) 201210074155.0

(51) Int. Cl. H01H 47/00

(52) U.S. Cl. 307/125

(57) ABSTRACT

An electronic device includes a power supply, a voltage sampling circuit, a processor, and a switching unit connected between the processor and the voltage sampling circuit. The voltage sampling circuit samples the voltage of the power supply. The processor monitors the sampled voltage. The processor further generates a first control signal when the electronic device is powered off. The switching unit cuts off the electrical connection between the power supply and the voltage sampling circuit in response to the first control signal.

### BACKGROUND

1. Technical Field

The present disclosure relates to electronic devices, and particularly relates to an electronic device with an internal battery.

2. Description of Related Art

Electronic device, such as DVD player, includes a battery, a processor, and a voltage sampling circuit. The battery provides a voltage for powering the processor. The voltage sampling circuit samples the voltage of the battery and includes a resistor connected between the battery and ground. The processor monitors the voltage of the battery according to the sampled voltage. The resistor forms a discharging path from the battery to ground. However, the resistor always dissipates the voltage of the battery even when the electronic device is powered off, and the battery will be discharged too quickly.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

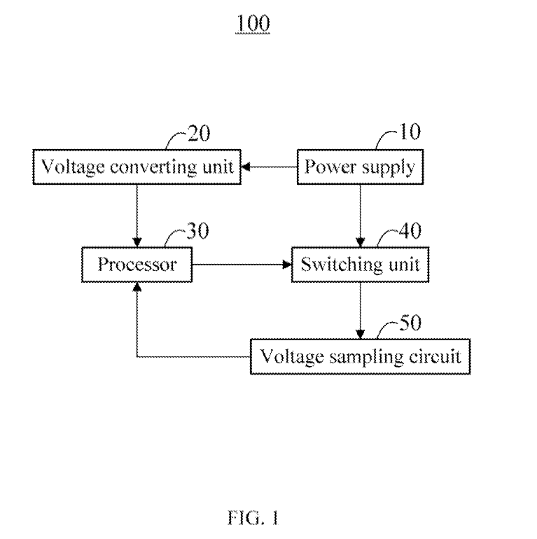

Referring to FIG. 1, an electronic device 100 includes a power supply 10, a voltage converting unit 20, a processor 30, a switching unit 40, and a voltage sampling circuit 50. The electronic device 100 can be powered on or powered off by the user, for example, in response to a power on command or a power off command from a remote controller. Furthermore, the electronic device 100 can receive other commands from the remote controller, and execute corresponding functions, for example, music playing function, and video playing function. In the embodiment, the electronic device 100 is a portable DVD player with an internal battery.

The power supply 10 provides a voltage to the voltage converting unit 20 and the switching unit 40. In the embodiment, the power supply 10 is a battery, and the voltage is 7.4V.

The voltage converting unit 20 converts the voltage of the power supply 10 to a working voltage and outputs the working voltage to drive the processor 30. In the embodiment, the working voltage is 3.3V.

The processor 30 generates a first control signal when the electronic device 100 is powered off, and generates a second control signal when the electronic device 100 is powered on. In the embodiment, the processor 30 is a micro control unit (MCU); the first control signal is a logic high voltage level, and the second control signal is a logic low voltage level.

The switching unit 40 is connected between the power supply 10 and the voltage sampling circuit 50. The switching unit 40 cuts off the electrical connection between the power supply 10 and the voltage sampling circuit 50 in response to the first control signal, therefore, the switching unit 40 forms a first discharging path for discharging the power supply 10. The switching unit 40 further establishes an electrical connection between the power supply 10 and the voltage sampling circuit 50 in response to the second control signal, therefore the voltage sampling circuit 50 forms a second discharging path for discharging the power supply 10 through the switching unit 40, and the first discharging path is cut off. In this embodiment, the power consumption of the voltage sampling circuit 50 is greater than the power consumption of the switching unit 40. Therefore, when the electronic device 100 is powered off, because the second discharge path is cut off excessive discharge of the power supply 10 is effectively prevented.

The voltage sampling circuit 50 samples the voltage of the power supply 10 when the electrical connection between the power supply 10 and the voltage sampling circuit 50 is established and outputs a sampled voltage to the processor 20. The processor 20 further monitors the voltage of the power supply 10 based on the sampled voltage. In the embodiment, the processor 20 determines whether the voltage of the power supply 10 is lower than a predetermined voltage according to the sampled voltage; the processor 20 performs a power off procedure to cause the electronic device 100 to be powered off when the processor 20 determines that the voltage of the power supply 10 is lower than the predetermined voltage.

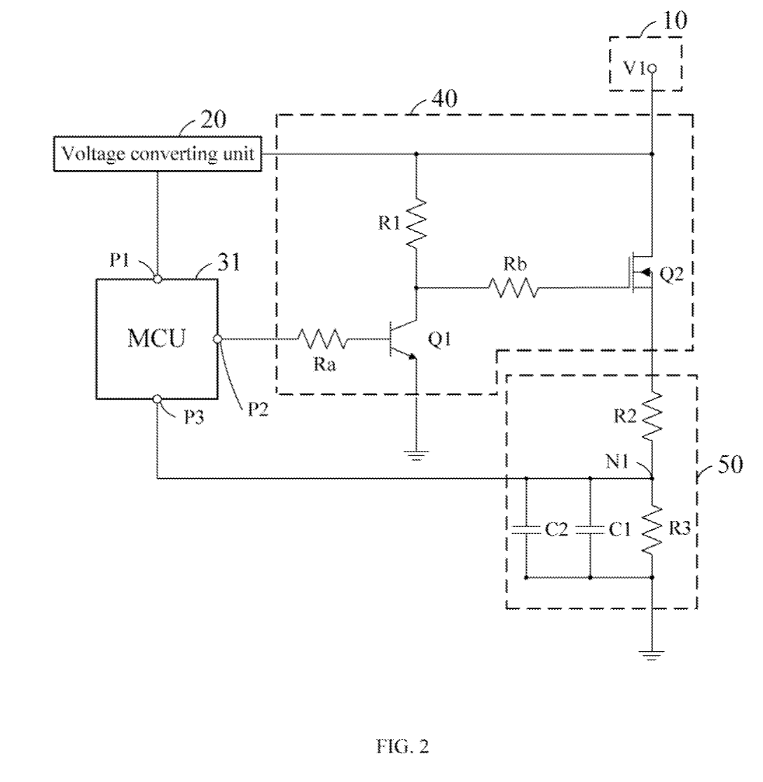

Referring to FIG. 2, the power supply 10 includes a power terminal V1. The power terminal V1 provides voltage to the processor 30 and the switching unit 40.

The processor 30 includes a MCU chip 31. The MCU chip 31 includes a first pin P1, a second pin P2, and a third pin P3. The first pin P1 is electronically connected to the voltage converting module 20, and is used for receiving the voltage. The second pin P2 is electrical connected to the switching unit 40, and is used for generating the first control signal or the second control signal. The third pin P3 is electrically connected to the voltage sampling circuit 50, and is used for receiving the sampled voltage.

The switching unit 40 includes a first transistor Q1, and a second transistor Q2, a first resistor R1, a first protecting resistor Ra, and a second protecting resistor Rb. A base of the first transistor Q1 is electrically connected to the second pin P2 through the first protecting resistor Ra. An emitter of the first transistor Q1 is grounded. A collector of the first transistor Q1 is electrically connected to the power terminal V1 through the first resistor R1. A gate of the second transistor Q2 is electrically connected to the collector of the first transistor Q1 through the second protecting resistor Rb. A drain of the second transistor Q2 is electrically connected to the power terminal V1. A source of the second transistor Q2 is electrically connected to the voltage sampling circuit 50. In the embodiment, the first transistor Q1 is an npn type bipolar junction transistor, and the second transistor Q2 is a n-channel enhancement type metal oxide semiconductor field effect transistor.

The voltage sampling circuit 50 includes a second resistor R2, a third resistor R3, a first capacitor C1, a second capacitor C2, and a node N1. An end of the second resistor R2 is electrically connected to the source of the second transistor Q2, and the other end of the second resistor R2 is grounded via the node N1 and the third resistor R3 in that order. One end of the first capacitor C1 is electrically connected to the node N1. The other end of the first capacitor C1 is grounded. The second capacitor C2 is electrically connected in parallel with the first capacitor C1. In the embodiment, the resistance of the resistor R1 is larger then the sum of the resistance of the second resistor R2 and the third resistor R3.

When the electronic device 100 is powered on, the second pin P2 outputs the second control signal. The difference in voltage between the base and the emitter of the first transistor Q1 is less than 0.7V and the first transistor Q1 is turned off. The voltage at the gate of the second transistor Q2 is equal to that of the power terminal V1, thus the difference in voltage between the source and the gate of the second transistor Q2 is greater than 0.7V and the second transistor Q2 is turned on. The first discharging path formed by the second transistor Q2, the second resistor R2, and the third resistor R3 is thus established. The second discharging path formed by the first transistor Q1 and the first resistor R1 is cut off. The third pin P3 receives the sampled voltage from the node N1 to monitor the voltage of the power terminal V1.

When the electronic device 100 is powered off, the second pin P2 outputs the first control signal. The difference in voltage between the base and the emitter of the first transistor Q1 is greater than 0.7V and the first transistor Q1 is turned on. The voltage at the gate of the second transistor Q2 is almost 0V. The difference in voltage between the source and the gate of the second transistor Q2 is thus less than 0.7V and the second transistor Q2 is turned off. The first discharging path formed by the second transistor Q2, the second resistor R2, and the third resistor R3 is cut off. A second discharging path formed by the first transistor Q1 and the first resistor R1 is established.

As described, the resistance of the first resistor R1 is larger than the sum of the resistance of the second resistor R2 and the third resistor R3, thus the electrical energy loss by the battery can be reduced. Therefore, the life of the battery is extended.

It is to be understood, however, that even though information and advantages of the present embodiments have been set forth in the foregoing description, together with details of the structures and functions of the present embodiments, the disclosure is illustrative only; and that changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising:
a power supply for providing a voltage;
a voltage sampling circuit adapted to sample the voltage to generate a sampled voltage;
a processor adapted to monitor the voltage of the power supply based on the sampled voltage; and
a switching unit connected between the power supply and the voltage sampling circuit;
wherein the processor generates a first control signal when the electronic device is powered off, and the switching unit cuts off an electrical connection between the power supply and the voltage sampling circuit in response to the first control signal.

2. The electronic device of claim 1, wherein when the switching unit cuts off the electrical connection between the power supply and the voltage sampling circuit, the switching unit further forms a first discharging path for discharging the power supply.

3. The electronic device of claim 2, wherein when the electronic device is powered on, the processor generates a second control signal; the switching unit establishes the electrical connection between the power supply and the voltage sampling circuit in response to the second control signal.

4. The electronic device of claim 3, wherein when the switching unit establishes the electrical connection between the power supply and the voltage sampling circuit, the voltage sampling circuit forms a second discharging path through the switching unit.

5. The electronic device of claim 4, wherein the power consumption of the voltage sampling circuit is greater than the power consumption of the switching unit.

6. The electronic device of claim 1, wherein the processor comprises a first pin for receiving the working voltage and a second pin for outputting the first control signal and the second control signal; the first pin is electrically connected to the power supply; the switching unit comprises a first transistor, a second transistor, and a first resistor; a base of the first transistor is electrically connected to the second pin, an emitter of the first transistor is grounded, a collector of the first transistor is electrically connected to the power supply via the first resistor; a gate of the second transistor is electrically connected to the collector of the first transistor, a drain of the second transistor is electrically connected to the power supply, a source of the second transistor is electrically connected to the voltage sampling circuit.

7. The electronic device of claim 6, wherein the first transistor is an npn type bipolar junction transistor, and the second transistor is a n-channel enhancement type metal oxide semiconductor field effect transistor.

8. The electronic device of claim 6, wherein the processor comprises a third pin for receiving the sampled voltage from the voltage sampling circuit; the voltage sampling circuit comprises a second resistor, and a third resistor; an end of the second resistor is electrically connected to the source of the second transistor, and the other end of the second resistor is grounded through the third resistor; the third pin is electrically connected between the second transistor and the third resistor.

9. The electronic device of claim 1, wherein the resistance of the first resistor is larger than the sum of the resistances of the second resistor and the third resistor.

10. The electronic device of claim 1, wherein the electronic device further comprises a voltage converting unit between the power supply and the processor; the voltage converting unit converts the voltage of the power supply into a working voltage and outputs the working voltage for driving the processor to work.

11. An electronic device comprising:
a power supply;
a voltage sampling circuit capable of forming a first discharging path for discharging the power supply; and
a switching unit capable of forming a second discharging path for discharging the power supply;
wherein when the electronic device is powered off, the first discharging path is cut off and the second discharging path is established; when the electronic device is powered on, the first discharging path is established and the second discharging path is cut off; the power consumption of the voltage sampling circuit is greater than the power consumption of the switching unit.

12. The electronic device of claim 11, wherein the electronic device further comprises a processor; the switching unit connected between the processor and the voltage sampling circuit; the processor generates a first control signal when the electronic device is powered off, the switching unit cuts off the electrical connection between the power supply and the voltage sampling circuit in response to the first control signal, and the switching unit cuts off the first discharging path and forms the second discharging path.

13. The electronic device of claim 12, wherein the processor generates a second control signal when the electronic device is powered on, the switching unit establishes the electrical connection between the power supply and the voltage sampling circuit in response to the second control signal, and the voltage sampling circuit forms the first discharging path through the switching unit.

14. The electronic device of claim 12, wherein the processor comprises a first pin for receiving the working voltage and a second pin for outputting the first control signal and the second control signal; the first pin is electrically connected to the power supply; the switching unit comprises a first transistor, a second transistor, and a first resistor; a base of the first transistor is electrically connected to the second pin, an emitter of the first transistor is grounded, a collector of the first transistor is electrically connected to the power supply via the first resistor; a gate of the second transistor is electrically connected to the collector of the first transistor, a drain of the second transistor is electrically connected to the power supply, a source of the second transistor is electrically connected to the voltage sampling circuit.

15. The electronic device of claim 14, wherein the first transistor is an npn type bipolar junction transistor, and the second transistor is a n-channel enhancement type metal oxide semiconductor field effect transistor.

16. The electronic device of claim 14, wherein the processor comprises a third pin; the voltage sampling circuit comprises a second resistor, and a third resistor; an end of the second resistor is electrically connected to the source of the second transistor, and the other end of the second resistor is grounded through the third resistor; the third pin is electrically connected between the second transistor and the third resistor.

17. The electronic device of claim 16, wherein the resistance of the first resistor is larger than the sum of the resistances of the second resistor and the third resistor.

18. The electronic device of claim 11, the electronic device further comprises a voltage converting unit between the power supply and the processor; the voltage converting unit converts the voltage of the power supply into a working voltage and outputs the working voltage to the processor.
